(19) United States
(12) Patent Application Publication
(10) Pub. No.: US 2024/0120456 A1
(43) Pub. Date: Apr. 11, 2024

(54) IONOMERS FOR IMPROVING THE DURABILITY OF MEMBRANE ELECTROCHEMICAL DEVICES AND ELECTRODES DERIVED THEREFROM

(71) Applicant: Georgia Tech Research Corporation, Atlanta, GA (US)

(72) Inventors: PAUL KOHL, Atlanta, GA (US); MRINMAY MANDAL, Atlanta, GA (US)

(21) Appl. No.: 18/276,792

(22) PCT Filed: Feb. 10, 2022
(86) PCT No.: PCT/US22/15921

§ 371 Date: Aug. 10, 2023

Related U.S. Application Data
(60) Provisional application No. 63/151,312, filed on Feb. 19, 2021.
(60) Provisional application No. 63/256,011, filed on Oct. 15, 2021.

(51) Int. Cl. H01M 4/04; H01M 4/88; H01M 6/18; H01M 8/1018

(52) U.S. Cl. CPC H01M 4/04; H01M 4/8878; H01M 6/181; H01M 8/1018

(57) ABSTRACT

An electrochemical device (100) includes an ion exchange membrane (120), a first electrode (110) adjacent to a first side thereof and a second electrode (130) adjacent to a second side thereof. At least one of the first electrode (110) and the second electrode (130) includes a current collector layer (112, 132) and a catalyzing layer (114, 134) applied thereto. The catalyzing layer (114, 134) includes an ion-conducting polymer (116), a plurality of electroactive catalyst particles (115, 118) and an adhesive (118) that binds the polymer (116), the catalyst particles (115, 118) and the current collector layer together (112, 132). In a method of making an electrode, an ion-conducting polymer, a plurality of electroactive catalyst particles and an adhesive are mixed in a solvent, which is applied to a current collector layer. The solvent is evaporated so that the adhesive binds the polymer and the catalyst particles to the current collector.

### CROSS-REFERENCE TO RELATED APPLICATION(S)

This application claims the benefit of U.S. Provisional Patent Application Ser. No. 63/151,312, filed Feb. 19, 2021 and US Provisional Patent Application Ser. No. 63/256,011, fled Oct. 15, 2021, the entirety of each of which is hereby incorporated herein by reference.

### STATEMENT OF GOVERNMENT SUPPORT

This invention was made with government support under grant number DE-EE0008833, awarded by the Department of Energy. The government has certain rights in the invention.

### BACKGROUND OF THE INVENTION

### 1. Field of the Invention

The present invention relates to anion-conducting polymers and, more specifically, to anion-conducting ionomers that also provide chemical adhesion between the components in the electrodes of electrochemical devices

### 2. Description of the Related Art

Hydrogen is a renewable and sustainable energy source for the evolving hydrogen economy. Hydrogen can be produced on-site in a distributed manner by electrolysis of water. The electrolysis of water can be performed using a high pH, or alkaline, liquid electrolyte (AE), proton exchange membrane (PEM), or anion exchange membrane (AEM). The AEM electrolyzer offers advantages over both AE and PEM electrolyzers. AEM devices can use low-platinum or no-platinum catalysts, as compared to PEM which uses iridium and platinum catalysts. The solid polymer electrolyte can be operated at higher current density than an AE liquid electrolyte and the membrane can support a pressure difference between the two electrodes allowing high-pressure dry hydrogen to be produced.

In addition to electrolyzers which produce hydrogen and oxygen, similar electrochemical devices can be used to convert hydrogen (or other fuels) and oxygen into electricity in a fuel cell or redox flow battery. Electrochemical devices using a solid polymer electrolyte can also be used to separate ions of various types, such as in electro-dialysis.

The electrochemical devices based on a solid-polymer electrolyte have at least two electrodes, one on each side of the ion-conducting polymer membrane. An oxidation reaction occurs at one electrode, and a reduction reaction occurs at the other electrode. In the case of water electrolysis using a hydroxide conducting membrane, water is reduced to hydrogen gas and hydroxide ions at the negative electrode, also called the cathode. The hydroxide ions produced at the cathode migrate to the positive electrode, also called the anode, where they are oxidized to form oxygen gas and water. Liquid water can be fed to the anode. The cathode can be run with or without water feed. When the cathode is run dry without a water feed, the water is supplied to the cathode by diffusion from the anode. Fuel cells operate by feeding hydrogen gas to the anode and oxygen (or air) to the cathode. Other electrochemical devices operate by feeding different gases or liquids to the electrodes.

Significant advancements have been made in AEM device performance by the creation of stable, hydroxide conductive membranes with long lifetimes. For example, the synthesis of poly(norbornene) (PNB) copolymers for use as anion-conducting membranes has been used. The PNB copolymers can be made into solid membranes by solvent-casting them into solid films with or without a porous, inert reinforcement layer. The mechanical properties of the membranes can be improved by cross-linking the PNB polymer chains with the use of a chemical cross-linker. However, the chemical cross-linker only bonds the polymer to itself and does not chemically bond the PNB to the porous reinforcement layer. The reinforcement layer is mechanically stable within the membrane because it is physically trapped within the PNB polymer.

Compact electrochemical devices can be constructed by attaching a high surface area anode and cathode electrode to the solid polymer membrane. The high surface area electrodes allow (i) chemical reactants/products, (ii) ions, and (iii) electrons from the external circuit to reach the catalytic, electrode sites where the electrochemical reactions occur, electrodes are necessary because they enable a high actual surface area within a small, compact volume situated on the membrane. Such three-dimensional electrodes can be made using catalytic metal powders, such as platinum for the electrolyzer cathode and iridium oxide for the electrolyzer anode. The catalyst can be sprayed onto the metal current collector or the membrane in the form of an ink which can be composed of catalyst powder, ion-conducting polymer (also called the ionomer) and solvent. The metal current collector, also referred to as a porous transport layer, can include a metallic mesh or fabric which provides the electrical pathway between the external circuit and the catalyst powder. The metallic mesh provides a high surface area, expanded area support for the catalyst and ionomer which together comprise the electrode. The jammer provides the ionic pathway between the ion conductive membrane and the catalyst policies. The porous nature of the metallic mesh or fabric also provides a pathway for chemical reactants and products to reach the catalyst sites.

Although progress has been made in producing higher performing catalysts and membranes, the electrode structure with catalyst particles and ionomer in contact with each other and the metallic mesh or fabric current collector can be vulnerable to physical forces dislodging the catalyst from the current collector. Unlike the situation where the reinforcement is trapped and stabilized within the polymer membrane, the ionomer and catalyst are not physically interlocked together, and there is no covalent chemical bonding between them. The chemical reactant or product formed at the electrodes can also exert forces on the ionomer and catalyst which can dislodge them from their location on the metal current collector. For example, in the electrolysis of water, liquid water can be supplied to the anode and vigorous gas evolution occurs at each electrode (i.e., oxygen at the positive anode and hydrogen at the negative cathode). The creation of oxygen gas at the anode and hydrogen gas at the cathode can cause catalyst particle detachment from the metal current collector. This results in poor electrolyzer durability over time because the active catalyst particles are dislodged from the current collector or rendered inactive because it is no longer connected to the ionomer (for ion transport to the membrane) or metal current collector (for electron transport to the external circuit).

Electrodes are made by mixing active catalyst particles with ion-conducting polymer and solvent to make a slurry which is sometimes called an ink. The slurry is sprayed onto the metal current collector which is usually a high surface area mesh or other porous layer so that the evolved gas can escape for external collection. The ion-conducting polymer within the electrode is often called the “ionomer”. However, in some cases, especially hydroxide conducting polymers, the jammer provides only minimal adhesion between the ionomer and catalyst, and ionomer and porous current collector. There is also little or no adhesion between the catalyst particles and metal current collector, such as hydrogen bonding. PEM polymers are known to provide a higher degree for adhesion than AEM polymers because the ionomer can have a sticky attribute allowing for suction (i.e., using a sticky polymer).

The lack of adhesion between the catalyst, metal current collector, and ion conduction ionomer in the electrode has resulted in poor lifetime for solid polymer electrolyzes and similar devices even though the individual components (i.e., membrane, catalyst, ionomer, and current collector) are themselves durable materials. Conventional adhesives, such as bis(phenol)-A-diglycidyl ether (BPADGE) epoxy, cannot be used to make the electrodes, in place of the ion-conducting ionomer, because BPADGE is not an ion conductor. A non-conducting polymer like BPADGE would block ion exchange between the catalyst and ion-conducting membrane, which is necessary for device operation.

Therefore, there is a need for a system for increasing adhesion between the catalyst, metal current collector, and ion conduction ionomer in the electrode

### SUMMARY OF THE INVENTION

The disadvantages of the prior art are overcome by the present invention which, in one aspect, is an anion-conducting polymer which can be made adherent to itself, the catalyst particles or layer, and the metal current collector layer. The inclusion of an adhesive-bondable site within the ion-conducting polymer followed by reaction of the adhesive-bondable site leads to structurally adherent electrodes where the catalyst sites are not inhibited by the chemically bonded ion-conducting polymer.

In another aspect, the invention is to incorporate the ion-conducting, adhesive polymer into the electrode structure of an electrochemical device to improve its durability. Another aspect of the invention uses the adhesive ionomers to make a durable membrane electrode assembly (MEA) which includes two three-dimensional electrodes and an ion-conducting membrane between the electrodes for use in electrolyzers, fuel cells, redone flow batteries, separation devices, and the like.

In another aspect, the invention is a method of incorporating an adhesive ion-conducting polymer into the electrode(s) of an electrochemical device.

In another aspect, the invention is an electrode of electrochemical device that includes a current collector layer and a catalyzing layer. The catalyzing layer is applied to the current collector layer and includes an ion-conducting polymer, a plurality of electroactive catalyst particles and an adhesive. The plurality of electroactive catalyst particles is distributed in the ion-conducting polymer. The adhesive binds the ion-conducting polymer, the plurality of electroactive catalyst particles and the current collector layer together.

In another aspect, the invention is an electrochemical device that includes an ion exchange membrane, a first electrode and a second electrode. The ion exchange membrane has a first side and an opposite second side. The first electrode is adjacent to the first side. The second electrode is adjacent to the second side. At least one of the first electrode and the second electrode includes a current collector layer and a catalyzing layer. The catalyzing layer is applied to the current collector layer and includes an ion-conducting polymer, a plurality of electroactive catalyst particles distributed in the ion-conducting polymer and an adhesive that binds the ion-conducting polymer, the plurality of electroactive catalyst particles and the current collector layer together.

In yet another aspect, the invention is a method of nutting an electrode for an electrochemical device, in which an ion-conducting polymer, a plurality of electroactive catalyst particles and an adhesive are mixed in a solvent so as to generate a mixture. The mixture is applied to a current collector layer. The solvent is allowed to evaporate substantially completely from the mixture so that the adhesive binds the ion-conducting polymer and the plurality of electroactive catalyst particles to the current collector layer.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1B are schematic diagrams of one representative embodiment of an electrochemical membrane system.

FIG. 2 is a graph showing the electrolysis voltage vs. time at 50° C. and 500 mA/cm² for throe different electrode formulations.

FIG. 3A is a chemical diagram showing an ionomer for use in anode and cathode using a triamine cross-linker which has at least one secondary amine which can react with added epoxy non-ionic adhesive.

FIG. 3B is a chemical diagram showing the synthesis of the Terpolymers: TP1 and TP2 with carboxylic acid functionality and TP3 with epoxy functionality.

FIG. 3C is a chemical diagram showing that when TP1 or TP2 are used as the ionomer in the electrodes, the copolymer containing —COOH functional groups is capable of reaction with an epoxy functionality, including multi functional epoxy compounds to cross-link polymer and adhere the polymer to both catalyst and current collector.

FIGS. 4A-4B are graphs showing electrolyzes voltage vs. time for TP2 ionomer with varying amounts of anode electro-catalyst.

### DETAILED DESCRIPTION OF THE INVENTION

A preferred embodiment of the invention is now described in detail. Referring to the drawings, like numbers indicate lice parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “n” includes “in” and “on.” Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the tam “about.” Where a numerical range is disclosed herein such range is continuous, inclusive of both the minimum and maximum values of the range as well as every value between such minimum and maximum values.

To solve the abovementioned problems, an anion-conducting polymer can be made adherent to itself, the catalyst particles, and the metal current collector. The ion-conducting, adhesive polymer can be incorporated into the electrode structure of electrochemical devices to improve its durability. Adhesive ionomers can make a durable membrane electrode assembly (MEA) which includes two electrodes and an ion-conducting membrane between the electrodes for use in electrolyzes, fuel cells, redox flow batteries, separation devices, and the like.

It has been found that the inclusion of an epoxy-bondable site within the ion-conducting polymer followed by reaction of the epoxy-bondable site leads to structurally adherent electrodes where the catalyst sites are not inhibited by the chemically bonded ionomer. More specifically, polymers were synthesized with multiple types of monomers, which provide (i) ion conductivity, (ii) epoxy functionality, (iii) sites for reacting with added epoxy compounds, and/or (iv) chemically inert sites to control other physical properties including water uptake and mechanical properties. Thus, the ionomers used to mike the electrodes can now provide ion conductivity, adhesion between the electrode components (i.e., catalyst powder, current collector, and polymer ionomer), and control over other physical properties (e.g., water swelling and elastic-plastic properties).

As used herein, the expression “alkyl” means a saturated, straight-chain or branched-chain hydrocarbon substituent having the specified number of carbon atoms. Particular alkyl groups are methyl, ethyl, n-propyl, isopropyl, tat-butyl, and so on. As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the lace. As used herein, the expression “alkenyl” means a non-cyclic, straight or branched hydrocarbon chain having the specified number of carbon atoms and containing at least one carbon-carbon double bond, and includes ethenyl and straight-chained or branched propenyl, butanyl, pentenyl, and hexenyl groups. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like. “Halogen” or “halo” means chlorine or chloro, fluorine or fluoro, bromine or bromo, and iodine or iodo. As used herein, “meal area” means the surface area of a structure as determined by its simple (length)×(width). The “real surface area” means the actual surface area taking into account the true topography of the surface and structure. It is understood that when a material is deposited and the surface area is referenced, the surface area in referenced is the “areal area”. As used herein, the expression “ionomer” means an anion-conducting solid polymer which can be used as ion-conducting medium in the electrodes acting as the ionic conduit between electroactive surface (e.g., catalyst particles) and electrolyte. Alternatively, the ionomer can be cast into a solid sheet and serve as the membrane between the two electrodes. In a broad sense, the term “substituted” includes all permissible substituents of organic compounds. In a few of the specific embodiments as disclosed herein, the term “substituted” means substituted with one or more substituents independently selected from the group consisting of C₁₋₆alkyl, C₂₋₄alkenyl, hydroxy, —CO₂H, an ester, an amide, C₁-C₆ alkoxy, —NH₂, halo-alkyl (halo being Cl, Br, I, or F), —NH lower alkyl, and —N(lower alkyl)₂. However, any of the other suitable substituents known to one skilled in the art can also be used in these embodiments. By the term “derived” is meant that the polymeric repeating units are polymerized (formed) from monomers by established polymerization methods. For example, polycyclic norbornene-type monomers can be polymerized, resulting in polymers formed by 2,3 enchainment of norbornene-type monomers as shown below.

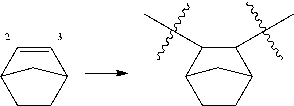

The above polymerization is also known as vinyl addition polymerization typically carried out in the presence of orgy nonmetallic compounds such as organo-palladium compounds or organ-nickel compounds as further described below. The polymers used contain at least two types of monomers: monomer “A”, monomer “B” and so forth. The monomers can be arranged in a random order within the polymer (e.g., -A-B-B-A-B-A-C-A-) or can be in the form of blocks (e.g., -A-A-A-B-B-B-B-C-C-C-). The monomers can be characterized as (i) resulting in ion conduction after being fully processed. (ii) have suitable functionality so that they are reactive with a known adhesive, or be an adhesive themselves, and/or (iii) have a functionality that gives the polymer certain physical properties, such as low water uptake or a degree of plasticity.

The term “ion-conducting polymer” means a molecule with at least two monomer units where at least one monomer is in the form R—XY. R is an organic moiety and —XY is an ionizable moiety. For example, in the case of an anion-conducting polymer, the ionizable moiety yields R-X+ and Y−. The cation X+ is immobile because it is chemically bonded to the polymer, R. and the anion Y− is a mobile anion because it is liberated or ionized from its counter ion. It is also understood that an “ion-conducting polymer” may also be synthesized in the form R—Z, where the moiety —Z is converted into —XY in a post synthesis treatment.

The term “adhesive polymer” means a polymer that contains either a chemical moiety which can be directly used for chemical bonding to other molecules, such as an oxirane (also known as epoxy) ring, or a chemical moiety that readily reacts with an adhesive compound, such as a carboxylic acid group (R—COOH) amine (R—NH₂), alcohol (R—OH) or other functional groups which can react with an epoxy adhesive.

Monomers which do not contribute to ion conduction or adhesion, “inert monomer” or “non-ion-conducting monomer”, may also be included in the polymer, such as R—CxHy. In this case, —CxHy is an alkyl moiety which does not chemically bond to other molecules present and does not conduct ions but serves other purposes such as lowering the water uptake of the polymer or providing unproved toughness.

The term “adhesive ion-conducting polymer” means a polymer which has ion-conducting monomers) and adhesive monomer(s) and optionally inert monomer(s). The tam “non-adhesive ion-conducting polymer” is one which contains only ion-conducting monomer(s) and optionally inert monomer(s). As used herein, a “non-adhesive ion-conducting polymer” can be cross-linked to other “non-adhesive ion-conducting polymer” chains via the —XY head group. These “non-adhesive ion-conducting polymers” are not considered adhesive because the cross-linking reaction does not chemically bond the polymer to other ingredients, such as the catalyst powder, current collector, and the like.

It has been found that if the ion-conducting polymer (i.e., ionomer) were replaced by a non-ion-conducting adhesive, such as BPADGE, the electrode performance would be poor because of the lack of an adequate ionic pathway between the ion-conducting membrane and electro-catalyst surface on the metal current collector. A person of ordinary skill in the art would also expect the approach of combining a non-adhesive hydroxide conducting polymer with a non-ion-conducting adhesive, such as BPADGE, would also result in low performance because the non-ion-conducting adhesive will dominate by covering the catalyst and render it inactive.

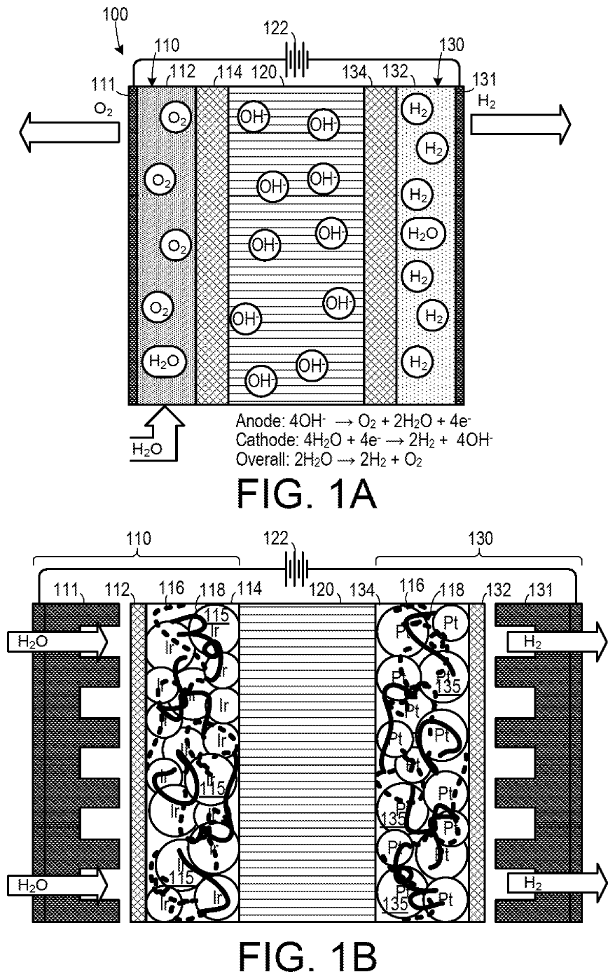

In one representative embodiment, as shown in FIGS. 1A-1B, an electrochemical device 100 for generating for example, hydrogen from water, can include an ion exchange membrane 120 with a first electrode 110 disposed on a first side thereof and a second electrode 130 disposed on a second, opposite side thereof. The first electrode 110 includes a conductor layer 111 which can have flow channels in it for supplying water and removing oxygen, coupled to a first terminal of a voltage source 122, a porous transport/current collector layer 112 (often called “current conducting layer” or “current conducting fabric”) for transporting water and oxygen disposed adjacent to the conductor layer 111 and a first catalyst layer 114 (also referred to as a “catalyzing layer”) disposed between the membrane 120 and the porous transport/currant collector 112. The fluid flow channels formed in the conductive layer 111 can have different shapes and connections to the outside (not shown in FIG. 1) based on the overall size of the electrolyzer. The first catalyst layer 114 includes a complex of particles of a first type of catalyst (e.g., iridium particles in one embodiment), ionomer chains 116 and adhesive particles 111. The second electrode 130 includes a conductor layer 131 coupled to a second terminal of the voltage source 122, a porous transport/current collector layer 132 for transporting water and oxygen disposed adjacent to the conductor layer 131 and a second catalyst layer 134 disposed between the membrane 120 a and a porous transport/current collector layer 132. The fluid flow channels formed in the conductive layer 131 can have different shapes and connections to the outside (not shown in FIG. 1) based on the overall size of the electrolyzer. The conductive layers 111 and 131 may have similar or different fluid flow channels depending on the electrolyzer design. The second catalyst layer 134 includes a complex of particles of a second type of catalyst (e.g., platinum particles in one embodiment), ionomer chains 116 and adhesive particles 116. As a voltage is applied between the first electrode 111 and the second electrode 130, the water is electrolyzed so as to separate into H₂ and O₂, which are removed from the electrochemical device 100.

In one experimental embodiment, Applicants have found that adding a minority or similar amount of BPADGE epoxy with respect to the hydroxide conducting polymer (i.e., ionomer) to the catalyst ink improves the electrolyzer durability without significantly hampering the overall cell performance.

### Example 1

In one experimental embodiment, electrolyzers were constructed using a 30 μm thick, reinforced poly(norbornene) membrane with 72 mol % of the monomers having a trimethyl ammonium hydroxide ion conductive substituent and 10% of the quaternary ammonium head groups were cross-liked with N,N,N′N′-tetramethyl-1,6-hexanediamine (TMHD). The oxygen-evolving anode was constructed using the method of Huang et al. where 4.8 mg/cm² lead ruthanate (PbRuOx) catalyst powder and 1.2 mg/cm² ionomer powder were suspended in solvent to form an ink. The anode ionomer was finely divided poly(norbornene) polymer with 72 mole % anion-conducting monomers of which 10 mole % was cross-linked with HMDA (“GT72-10 ionomer”). The anode ink was sprayed onto a nickel mesh current collector. As previously described by Huang et al., the hydrogen evolving cathode contained 0.86 mg/cm² poly(norbornene) ionomer with 72 mole % ion-conducting quaternary ammonium monomers of which 3 mole % was cross-linked by HMDA. The cathode catalyst war 3 mg/cm² Pt₃Ni alloy. Liquid water containing 0.1 M NaOH was fed to the anode. The cell was operated at 50° C. and at 500 mA/cm² constant current.

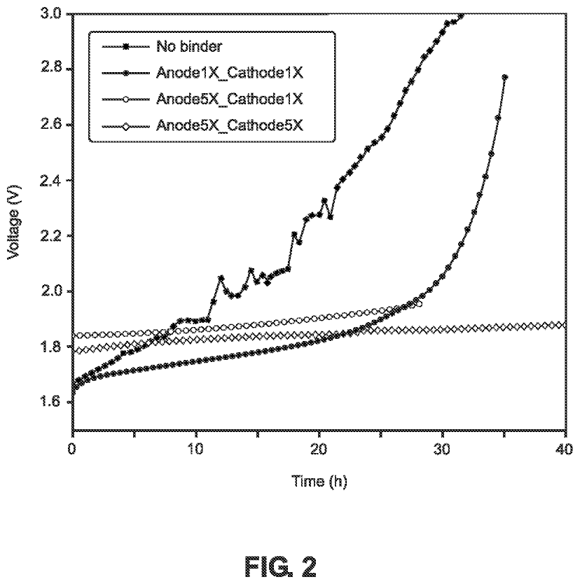

Initially, the anode and cathode were fabricated without the addition of non conductive epoxy binder (“No binder”), as shown in FIG. 2. The initial voltage was a favorable 1.65 V, however, the applied voltage quickly nose to over 2 V in 12 hr. When operated, anode catalyst particles were seen in the anode-fed water as they were dislodged from the anode current collector. When the cell was disassembled, cathode catalyst particles were observed at the hydrogen exit port as they were also dislodged from the cathode current collector.

A second set of electrodes was made following the same procedure described above with the same materials; however, an aliquot of a commercial two-part epoxy was included in each ink before spray coating the inks onto their respective current collectors. The two-part epoxy (e.g., JB Weld 8265S) was added to each electrode ink formulation prior to spray coating the catalyst/ionomer/epoxy/solvent inks. In this embodiment, the JB Weld 8265S epoxy amount was to 0.65 mg/cm² of electrode area. This quantity of epoxy is designated as “Anode1×_Cathode1×”. When 1× aliquot of epoxy and hardener were added to each electrode, the initial cell voltage was an acceptable value, about 1.68 V. The cell voltage slowly increased with time, however, it did not exceed 2 V until 30 hr, a significant improvement compared to the “No binder” case. Although this formulation was an improvement over “No binder”, dislodged catalyst particles were again observed. Catalyst particles were more obvious at the oxygen evolving anode, compared to the cathode, due to the forces created within the anode where the flowing water stream was converted into oxygen gas. Increasing the epoxy content in the oxygen-evolving positive electrode by five-fold for the oxygen evolving reaction (OER) while keeping the hydrogen evolving reaction (HER) at 1× (as shown in FIG. 2: Anode5×_Cathode1×) improved adhesion of the oxygen catalyst without significantly disabling its catalytic activity. The 5× epoxy additive was accomplished by adding 3.25 mg/cm² of JB Weld 8265S. The 5× epoxy at the oxygen electrode does cause the initial voltage to increase, compared to the “Anode1×_Cathode1×” case. This penalty is due to a decrease in the exposed anode catalyst area.

Also, it was found that adding five-fold epoxy to the hydrogen-evolving cathode resulted in further improvement in stability to greater than 60 hr. That is, the rate of increase in applied voltage decreased with higher epoxy loadings in each electrode. Although it is evident that the durability improved significantly with higher epoxy loading, the cell voltage continued to increase slowly with time, although at a slower rate. One of ordinary skill in the art would recognize that further optimization of these results is possible without undue experimentation by changing the amount of added epoxy and ionomer-to-catalyst-to-epoxy ratio.

Example 1 shows that the addition of a non-ion conductive adhesive to the electrode ink increases the electrolysis cell voltage only slightly while significantly improving adhesion and durability of the both the anode and cathode.

It was found that other methods of forming the electrodes with enhanced adhesion are possible. The results shown in FIG. 2 demonstrate that adding a non-ion-conducting adhesive to an existing electrode-forming ink can help stabilize the catalyst particles by chemically binding them together and to the metal current collector. However, the ion-conducting ionomer in each electrode in FIG. 2 does not have epoxy bondable sites so that the ionomer adhesion to the electrode and metal current collector is accomplished only by physical entrapment of the non-adhesive ion-conducting ionomer.

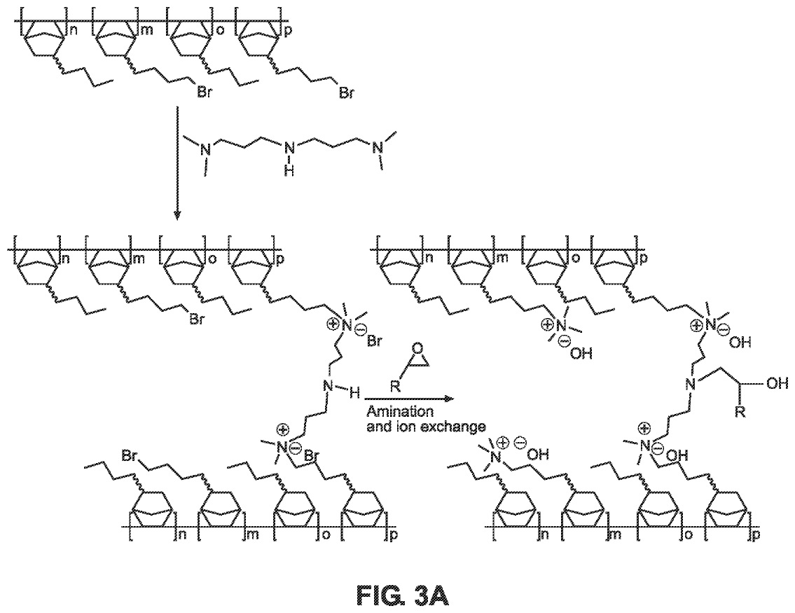

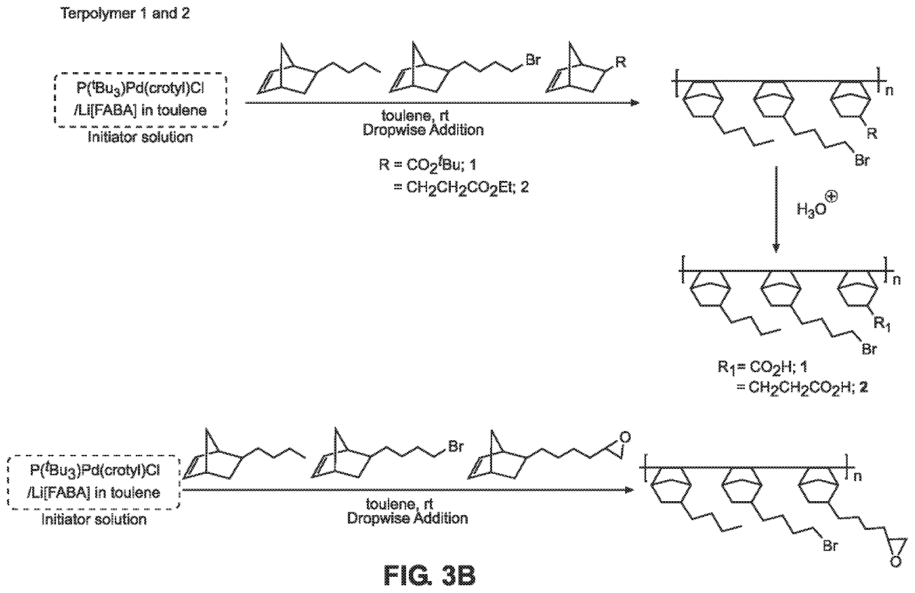

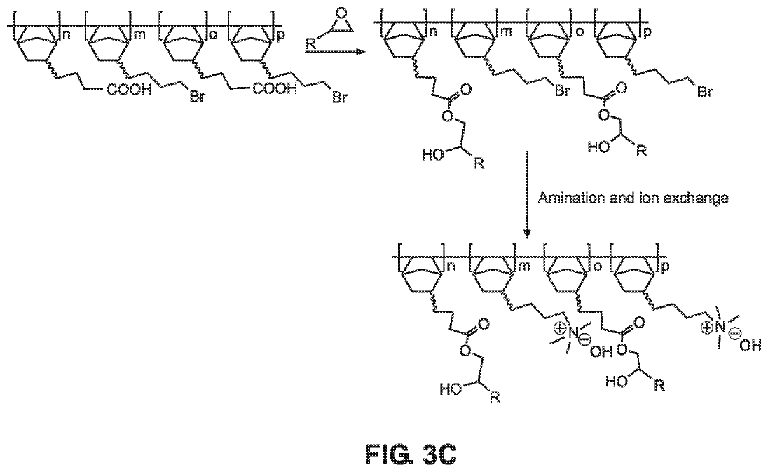

One experimental embodiment used the ionomer of Scheme 1, as shown in FIG. 3M, in which the use of a trifunctional amine cross-linker that was used to provide a secondary amine site within the cross-linker which can react with the added epoxy, in addition to the presence of two tertiary amine moieties which can cross-link the ionomer, as in Example 1. In this way, the hydroxide conducting polymer chemically binds into the epoxy network in addition to cross-linking the individual ion-conducting ionomer strands. The use of the triamine cross-linked ionomer in place of the ionomers used in FIG. 2 resulted in a more stable electrolysis voltage for more than 100 hr.

In another embodiment, Applicants have discovered that new ion-conducting ionomers can be synthesized for added adhesion and durability with other components in the electrodes by inclusion of new monomers in the ion-conducting ionomer. Polymers with more than two types of monomers (i.e., terpolymers, tetrapolymers, etc.) allow for additional control over ionomer and membrane properties. The additional control includes: (i) adhesion to catalyst, current collector, other ionomer molecules, and binder, (ii) ionic conductivity by selection of the fraction of ion-conducting monomers, (iii) mechanical properties such as toughness and water uptake. Thus, the inclusion of adhesion-capable monomers in the ion-conducting polymer allows the ratio of ion-conducting monomers, non-ion-conducting monomers and adhesive-monomers to be independently varied. Scheme 2, as shown in FIG. 3B, shows the synthesis of adhesive ion-conducting polymers, which may be used as the ionomer in the electrodes or in the membrane itself. An epoxy friendly R—COOH group is formed in the ion-conducting polymer itself after inclusion of a suitable monomer in the polymer chain through synthesis. The example shown in FIG. 3B—Scheme 2—is foe an anion conductive polymer, however, cation conductive copolymers also benefit from this approach. In an anion-conducting jammer, the hydroxyl part of the carboxylate group can react with an epoxy-containing compound and provide crosslinking of the polymer to the epoxy, as demonstrated in Scheme 3, as shown in FIG. 3C. Alternatively, the —COOH group in scheme 2 (Terpolymer 1 and Terpolymer 2) can be replaced with an oxirane (i.e., epoxy) ring, Terpolymer 3. In the case of Terpolymer 3, the hydroxide conducting polymer itself can be directly crosslinked to other epoxy moieties and can directly react with the catalyst, current collector, or other electrode components for added adhesion.

### Example 2

The terpolymers shown in FIG. 3C—Scheme 3—were synthesized in the following manner. The polymer synthesis catalyst was prepared in a nitrogen filled glove box by mixing P(tBu₃)Pd(crotyl)Cl (Pd-162; Johnson Matthey) and lithium)-borate·(2.5Et₂O) (Li[FABA]) in a 1:1 mole ratio. A mixture of toluene and trifluorotoluene (TFT) was used as the solvent and the mixture was stirred for 20 min to generate the cationic Pd complex which is active for vinyl addition polymerization of monomers. The monomers, butyl norbornene (BuNB) at 58 mol %, bromobutyl norbornene (BBNB) at 28 mol %, and test-Butyl ester norbornene (terpolymer 1) at 18 mol %, norbornene-2-propionic acid ethyl ester (terpolymer 2), or epoxyhexyl norbornene (terpolymer 3) at 18 mol % were mixed together in a round-bottomed flask and purified through three successive freeze-pump-thaw cycles. The mole percent of the three monomers can be varied to increase any of the polymer features including ion conductivity (BBNB mole percent), adhesion (tert-butyl ester norbornene or norbornene-2-propionic acid ethyl ester or epoxyhexyl norbornene mole percent), or water uptake/mechanical properties (butyl norbornene mole percent). Next, toluene was added to make a 5 wt % solution of the monomers. The monomer solution was added dropwise (10 s per drop) to the catalyst solution and stirred vigorously. After the addition was complete, the reaction mixture was stirred for 24 hr and taken out of the glove box followed by three precipitation steps into methanol. The resulting polymer was dissolved in toluene and stirred over activated charcoal. The solution was passed through an alumina filter to remove any palladium catalyst residue. The resulting product was precipitated in methanol. The polymer product was dried under vacuum at 60° C. The tat-butyl ester norbornene (in terpolymer 1) and norbornene-2-propionic acid ethyl ester (in terpolymer 2) were converted into carboxylic acid groups (R—COOH) by treating the polymer with concentrated hydrochloric acid for 24 hr.

The electrolyzer anodes were made by a solvent-cast method where an airbrush was used to spray catalyst ink directly onto the current collector. The baseline oxygen evolving electrode ink formulation used 35 mg ion-conducting ionomer stirred in 3 ml tetrahydrofuran (THF) until dissolved to form a transparent solution. The solution was filtered through a cotton filter to remove impurities. 22 mg of EPON 826 epoxy-based, BPADGE adhesive binder dissolved in THF was added and stirred for 10 min. NiFeOx (nickel ferrite) catalyst was added and sonicated in ice bath for at least 1 h. The slurry was sprayed onto a nickel fiber or titanium mesh current collector resulting. The final loading of catalyst, BPADGE and ionomer was 2 mg/cm², 0.3 mg/cm², and 0.5 mg/cm². The abovementioned amounts of EPON 826 BPADGE epoxy is designated as “1× epoxy”. Higher epoxy loadings were also used and designated as 2× when twice the epoxy loading was used, etc.

The electrolyze cathodes were prepared using a grind-cast method 25 mg of dry ionomer was ground in a mortar and pestle for 5 min. 1.3 ml of DI water was added and the mixture was ground for 1 min. Pt₃Ni catalyst was added to the mortar and ground for another 5 min followed by the addition of 15 mg JB Weld 8265S Part A adhesive dissolved in acetone and 12 mg of Part B epoxy hardener dissolved in isopropanol (WA). The mixture was ground for 5 min. followed by the addition of 12 ml isopropanol. The ink was transferred to a vial and sonicated for 1.5 hr in an ire bath. The ink was sprayed onto a carbon paper PTL. The final loading of catalyst, epoxy and ionomer was 1.5 mg/cm², 0.4 mg/cm², and 0.375 mg/cm². The electrodes were cured by heating in an oven at 160° C. for 1 hr.

The electrolyzes were made by cutting electrodes from the anode and cathode electrode sheets. The electroactive area in the electrolyzer was 4 cm². The poly(norbornene) membrane was 72 mole % ion-conducting monomers and 10% of the ion-conducting monomers were cross-linked with TMHA. The electrodes and membrane were pressed together between two 316 stainless steel single-paw serpentine flow-field conductive layers (111 and 131 as shown in FIGS. 1A and 1B). A Tefzel-type gasket, 0.30 mm total thickness, was used around the electrodes to seal the membrane electrode assembly (MEA) in the stainless-steel cell blocks. The MEA was held in the cell blocks (111 and 131 as shown in FIGS. 1A and 1B) with bolts at an applied torque of 25 in-lb.

The electrolyzers were operated with 0.1M NaOH water recirculated to the anode at 60° C. The cell was conditioned at 100 mA/cm² until the voltage equilibrated. The current density was gradually increased to 750 mA/cm² or 1,000 mA/cm² in incremental steps. The cell voltage was recorded as a function of time at constant current load for the durability tests.

### Example 3

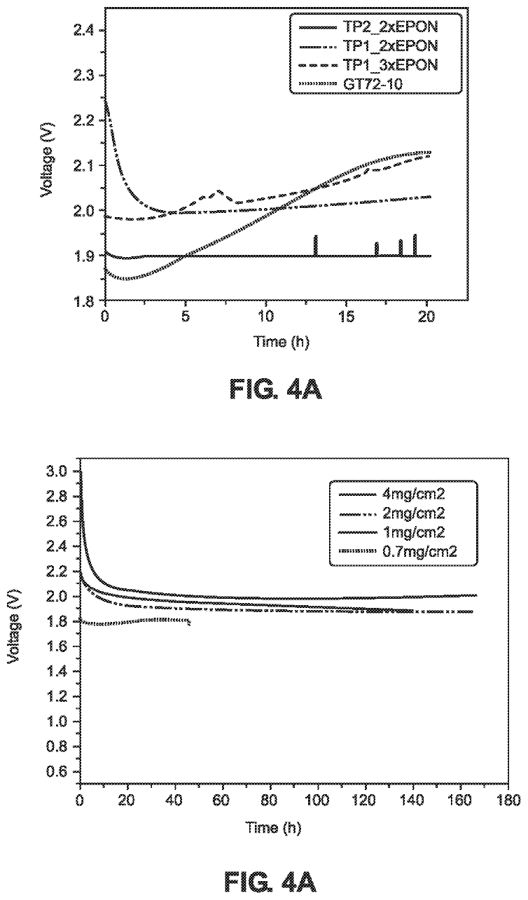

The resulting performance for electrolysis using 0.1 M KOH feed at the anode at 50′C and 1,000 mA/cm² is shown in FIGS. 4A-4B. Electrolysis using GT72-10 ionomer only in the anode with no non-conductive binder had an initial low applied voltage but the voltage rose quickly with time as the catalyst particles became dislodged from the anode current collector. GT72-10 ionomer has 72 male % ion-conducting groups in the copolymer and 10 mole % cross-linker. The electrodes made with TP1 terpolymer and 2× or 3× epoxy, as described in Example 2, showed better performance, however, slow increase in the voltage occurred, an undesirable effect. It is noted that the electrodes made with TP1 ionomer had substantially better adhesion of the catalyst to the current collector. The catalyst was clearly stack to the current collector with the adhesive ion-conducting ionomer and added epoxy. There was little or no catalyst observed leaving the electrode during operation. These results with TP1 show that the added epoxy reacts with the other components in the electrode, including ionomer, to give improved adhesion. Finally, the electrolysis performance with TP2 was demonstrated. The voltage shown in FIG. 4A was very stable over the 20 hr period shown in FIG. 4A and continued to show stable voltage over 100 hr, at which time the experiment was terminated while still operating at the same voltage. These result shows that the terpolymer ionomers were adhesive with the other components in the electrode and did not cause unacceptable increases in the initial electrolysis voltage. It also shows that the additional alkyl length between the norbornene backbone and the —COOH group in TP2 gives the functional unit added chain segment mobility to react with epoxy and improve electrolyzer performance.

### Example 4

The examples and formulations contained herein can be further improved without undue experimentation. For example, the amount of catalyst used in Example 3 with TP2 2×EPON in the anode was repeated, as shown in FIG. 4B. The electrolyzes voltage was further improved by lowering the amount of catalyst in the electrode. The skilled artisan would know that excess catalyst leads to a thicker sprayed layer that may increase the overall electrode resistance. For each electrode formulation, there is an optimum catalyst loading to produce the highest performing electrode. If there is too little catalyst the electroactive surface area is sub-optimal. If there is excess catalyst, the electrode resistance is too high. The optimum catalyst (and other) loading balances the off setting effect.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(1) unless the words “means far” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An electrode of electrochemical device, comprising:
(a) a current collector layer;
(b) a catalyzing layer applied to the current collector layer, including:
(i) an ion-conducting polymer;
(ii) a plurality of electroactive catalyst particles distributed in the ion-conducting polymer; and
(iii) an adhesive that binds the ion-conducting polymer, the plurality of electroactive catalyst particles and the current collector layer together.

2. The electrode of claim 1, wherein the =rent collector layer comprises a selected one of a metal mesh or a metal fabric.

3. The electrode of claim 1, wherein the adhesive comprises a non-ion-conducting polymer.

4. The electrode of claim 3, wherein the non-ion-conducting polymer comprises an epoxy-based adhesive.

5. The electrode of claim 1, wherein the adhesive comprises an ion-conducting Poly.

6. The electrode of claim 5, wherein the ion-conducting polymer comprises a poly(norbornene)-based adhesive.

7. An electrochemical device, comprising:
(a) an ion exchange membrane having a first side and an opposite second side;
(b) a first electrode adjacent the first side; and
(c) a second electrode adjacent the second side;
wherein at least one of the first electrode and the second electrode includes:
(i) a current collector layer;
(n) a catalyzing layer applied to the current collector layer, including:
(1) an ion-conducting polymer;
(2) a plurality of electroactive catalyst particles distributed in the ion-conducting polymer; and
(3) an adhesive that binds the ion-conducting polymer, the plurality of electroactive catalyst particles and the current collector layer together.

8. The electrochemical device of claim 7, wherein the current collector layer comprises a selected one of a metal mesh or a metal fabric.

9. The electrochemical device of claim 7, wherein the adhesive comprises a non-ion-conducting polymer.

10. The electrochemical device of claim 9, wherein the non-ion-conducting polymer comprises an epoxy-based adhesive.

11. The electrochemical device of claim 7, wherein the adhesive comprises an ion-conducting polymer.

12. The electrochemical device of claim 11, wherein the ion-conducting polymer comprises a poly(norbornene)-based adhesive.

13. A method of making an electrode for an electrochemical device, comprising the steps of:
(a) mixing an ion-conducting polymer, a plurality of electroactive catalyst particles and an adhesive in a solvent so as to generate a mixture;
(b) applying the mixture to a current collector layer;
(c) allowing the solvent to evaporate substantially completely from the mixture so that the adhesive binds the ion-conducting polymer and the plurality of electroactive catalyst particles to the current collector layer.

14. The method of claim 13, wherein the applying step comprises the step of spraying the mixture onto the current collector layer.

15. The method of claim 13, wherein the current collector layer comprises a selected one of a metal mesh or a metal fabric.

16. The method of claim 13, wherein the adhesive comprises a non-ion-conducting polymer.

17. The method of claim 16, wherein the non-ion-conducting polymer comprises an epoxy-based adhesive.

18. The method of claim 13, wherein the adhesive comprises an ion-conducting Polymer.

19. The method of claim 18, wherein the ion-conducting polymer comprises a poly(norbornene)-based adhesive.
